(19) United States
(12) Patent Application Publication
(10) Pub. No.: US 2019/0344177 A1
(43) Pub. Date: Nov. 14, 2019

(54) BitChain Puzzle Game

(71) Applicant: Gyora BENEDEK, Kiriat Bialik (IL)

(72) Inventor: Gyora BENEDEK, Kiriat Bialik (IL)

(21) Appl. No.: 16/406,070

(22) Filed: May 8, 2019

Related U.S. Application Data
(60) Provisional application No. 62/669,421, filed on May 10, 2018.

(51) Int. Cl. A63F 13/537; A63F 13/80; A63F 13/35

(52) U.S. Cl. CPC A63F 13/537; A63F 13/35; A63F 13/80

(57) ABSTRACT

A puzzle game comprising: a game play interface configured to display a pattern of associated cells with at least some of the associated cells containing a visually distinguishable indicator, the visually distinguishable indictor being one of two or more types, such that the visually distinguishable indicator indicates an individual associated cell's order in a repeating sequence along a predetermined solution path in the pattern of associated cells and the pattern of associated cells is configured such the solution path is traced by passing through all the associated cells in the pattern while maintaining the repeating sequence of the visually distinguishable indicators and without traversing any cell twice.

### FIELD AND BACKGROUND OF THE INVENTION

The present invention relates to puzzle games and, in particular, it concerns a puzzle game having a pattern of associated cells with at least some of said associated cells containing a visually distinguishable indicator, said visually distinguishable indictor being one of two or more types, such that said visually distinguishable indicator indicates an individual associated cell's order in a repeating sequence along a predetermined solution path in said pattern of associated cells and said pattern of associated cells is configured such said solution path is traced by passing through all said associated cells in said pattern while maintaining said repeating sequence of said visually distinguishable indicators.

### SUMMARY OF THE INVENTION

The present invention is a puzzle game a pattern of associated cells with at least some of said associated cells containing a visually distinguishable indicator, said visually distinguishable indictor being one of two or more types, such that said visually distinguishable indicator indicates an individual associated cell's order in a repeating sequence along a predetermined solution path in said pattern of associated cells and said pattern of associated cells is configured such said solution path is traced by passing through all said associated cells in said pattern while maintaining said repeating sequence of said visually distinguishable indicators.

According to the teachings of the present invention there is provided a puzzle game comprising: a game play interface configured to display a pattern of associated cells with at least some of the associated cells containing a visually distinguishable indicator, the visually distinguishable indictor being one of two or more types, such that the visually distinguishable indicator indicates an individual associated cell's order in a repeating sequence along a predetermined solution path in the pattern of associated cells and the pattern of associated cells is configured such the solution path is traced by passing through all the associated cells in the pattern while maintaining the repeating sequence of the visually distinguishable indicators and without traversing any cell twice.

According to the teachings of the present invention there is also provided that the game play interface is represented on an electronic display.

According to the teachings of the present invention there is also provided that all of the associated cells in the pattern contain a visually distinguishable indicator.

According to the teachings of the present invention there is also provided that the visually distinguishable indicators are at least one chosen from a group including visual forms such as, but not limited to, colors, letters, numerals, icons and graphic symbols.

According to the teachings of the present invention there is also provided a predetermined relationship between each one of the associated cells includes, but is not limited to, an allowable direction of movement from one the associate cell to a next associated cell on the solution path.

According to the teachings of the present invention there is also provided that the allowable direction of movement is similar to a move that can be made by a chess piece on a chessboard during a game of chess.

According to the teachings of the present invention there is also provided that the associated cells are hexagonal in shape and the allowable direction of movement is to any adjoining associated cell.

According to the teachings of the present invention there is also provided a portion of the solution path is pre-placed in its predetermined position along the solution path by a game setter prior to a beginning of play.

According to the teachings of the present invention there is also provided that the solution path is configured such that there is a single solution path between a starting point and an end point.

According to the teachings of the present invention there is also provided that the solution path is configured such that the solution path is cyclic without a starting point and an end point.

According to the teachings of the present invention there is also provided a computer program programmed to at least: determine a type of the associated cells; determine adjacency of the associated cells; determine a size and shape of the pattern of associated cells; and determine a difficulty level of the puzzle.

According to the teachings of the present invention there is also provided that the computer program generates a game play interface displayed on the display element.

There is also provided according to the teachings of the present invention a method of forming a puzzle game, the method comprising: providing a computer program configured to determine at least one parameter of game play; generating a game play interface configured to display a pattern of associated cells with at least some of the associated cells containing a visually distinguishable indicator, the visually distinguishable indictor being one of two or more types, such that the visually distinguishable indicator indicates an individual associated cell's order in a repeating sequence along a predetermined solution path in the pattern of associated cells and the pattern of associated cells is configured such the solution path is traced by passing through all the associated cells in the pattern while maintaining the repeating sequence of the visually distinguishable indicators and without traversing any cell twice; and providing the game play interface to a device for presenting the game play interface to a user.

According to the teachings of the present invention there is also provided that at least one algorithm for determining the at least one parameter of game play.

According to the teachings of the present invention there is also provided that the at least one parameter of game play includes at least one of: determine a of the associated cells; determine adjacency of the associated cells; determine a size and shape of the pattern of associated cells; and determine a difficulty level of the puzzle.

According to the teachings of the present invention there is also provided that the adjacency is implemented as a move that can be made by a chess piece on a chessboard during a game of chess.

According to the teachings of the present invention there is also provided that the adjacency is implemented as a move to any adjoining associated cell.

According to the teachings of the present invention there is also provided that the game play interface is printed material.

According to the teachings of the present invention there is also provided that the game play interface is represented on an electronic display.

According to the teachings of the present invention there is also provided that the computer program is deployed on a server so as to provide game play to client devices.

### BRIEF DESCRIPTION OF THE DRAWINGS

The invention is herein described, by way of example only, with reference to the accompanying drawings, wherein:

FIG. 1 is an example of an embodiment of a game play interface having hexagonal tiles with start and end tiles indicated, constructed according to the teachings of the present invention, shown here before game play has begun;

FIG. 2A is an example of a smaller game play interface having hexagonal tiles with start and end tiles indicated and one “given”, shown here before game play has begun;

FIG. 2B is the game play interface of FIG. 2A after completion of the game;

FIG. 3A is an example of a game play interface having square tiles with start and end tiles indicated and in which only horizontal and vertical connections are allowed, shown here before game play has begun;

FIG. 3B is the game play interface of FIG. 3A after completion of the game;

FIG. 4A is an example of a game play interface having square tiles with start and end tiles indicated and in which horizontal, vertical and diagonal connections are allowed, shown here before game play has begun;

FIG. 4B is the game play interface of FIG. 4A after completion of the game;

FIG. 5A is an example of a game play interface having square tiles and a cyclic path with no start and end tiles indicated and in which horizontal, vertical and diagonal connections are allowed, shown here before game play has begun;

FIG. 5B is the game play interface of FIG. 5A after completion of the game;

FIG. 6A is an example of a more complex game play interface having square tiles and a cyclic path with no start and end tiles indicated and in which horizontal, vertical and diagonal connections are allowed, shown here before game play has begun;

FIG. 6B is the game play interface of FIG. 6A after completion of the game;

FIG. 7A is another example of a more complex game play interface having square tiles and a cyclic path with no start and end tiles indicated, in which horizontal, vertical and diagonal connections are allowed and having a wall blocking a connection between adjacent tiles, shown here before game play has begun;

FIG. 7B is the game play interface of FIG. 7A after completion of the game; and

FIG. 8A is an example of a game play interface having square tiles with start and end tiles indicated, a repeating sequence of 3 different visually distinguishable indicators and in which horizontal, vertical and diagonal connections are allowed, shown here before game play has begun;

FIG. 8B is the game play interface of FIG. 8A after completion of the game;

FIGS. 9 and 10 are examples of game play interfaces having hexagonal tiles and a cyclic path with no end tiles indicated in which some of the tiles are blocked from play, shown here before game play has begun.

### DESCRIPTION OF THE PREFERRED EMBODIMENTS

The present invention is a puzzle game having a pattern of associated cells with at least some of said associated cells containing a visually distinguishable indicator, said visually distinguishable indictor being one of two or more types, such that said visually distinguishable indicator indicates an individual associated cell's order in a repeating sequence along a predetermined solution path in said pattern of associated cells and said pattern of associated cells is configured such said solution path is traced by passing through all said associated cells in said pattern while maintaining said repeating sequence of said visually distinguishable indicators.

The principles and operation of a puzzle game according to the present invention may be better understood with reference to the drawings and the accompanying description.

By way of introduction, it will be appreciated that the visually distinguishable indicators disclosed herein are used to indicate the placement/order within a pre-set repeating sequence along the predetermined solution path of each tile. That is to say, that the visually distinguishable indicator in a tile is also an indication of the visually distinguishable indicators in the previous tile in the solution path as well as the next tile in the solution path. Therefore, the allowable moves to and from each individual tile are limited by the particular visually distinguishable indicator of the tile based on the rules of that particular BitChain puzzle. It should be noted that the term “order” as used herein to mean the position of a cell in the repeating sequence.

In its simplest form, the puzzle game of the present invention, commercially referred to as a BitChain puzzle, consists of a field of play that is a pattern of associated positions, of cells, depicted as tiles. Each of the tiles contains a visually distinguishable indicator depicted by one of the numerals “0” or “1”. To solve the puzzle one must trace a path that traverses all tiles while alternating between “0” and “1” tiles in a repeating sequence. In this simplest form, the solution path has end points marked as givens in the solution. It will be appreciated that each of the end points may be used as the starting or ending point of the path and therefore are referred to herein as start/end tiles. It should be noted that the term “trace” in all its grammatical variations is used herein to include all means of visibly marking the solution path and following the solution path without visual markings. Non-limiting examples of visibly marking the solution path include pen or pencil lines drawn on a game play interface printed on paper and lines drawn on an electronic display using an input device. A non-limiting example following the solution path without visual markings includes traversing the solution path on a game play interface printed on paper using a implement without leaving any markings or moving the cursor displayed on an electronic display along the solution path without marking a line along the path.

It will be appreciated that the tiles can be of various shapes such as, but not limited to, squares, triangles and hexagons. It should be understood that in general, a field of play will be made up of tiles of the same shape. However, this is not meant as a limitation and a field of play having a variety of tile shapes is within the scope of the present invention.

As will be explained below in detail with respect to the drawings, in some embodiments of the puzzle game of the present invention, the field of play is a grid of tiles in which some of the squares are empty and are included in the field of play to be filled by the player while solving the puzzle. Other tiles may be excluded from the field of play. These tiles may be noticeably indicated as blocked from play by, for example, being completely colored in. Alternately, squares excluded from the field of play may be left empty so as to appear to the player as being included in the field of play. Therefore, it will be up to the player to eliminate such squares from the field of play as part of finding the solution to the puzzle. Another variation includes barriers between tiles that cannot be traversed. The puzzle may also include one or more partial paths consisting of lines traversing two or more tiles that are included in the field of play as a given in the solution of the puzzle that must be included in the solution.

While the simplest form of a BitChain puzzle has two visually distinguishable indicators, “0” and “1”, in more complex variations the tiles may contain a greater variety of visually distinguishable indicators, such that each one of the different visually distinguishable indicators indicates the individual tile's place along the predetermined solution path.

In such a game field the number of different visually distinguishable indicators is predetermined as well as the repeating sequence of the individual visually distinguishable indicators in the solution path. Therefore, the tiles may be marked with k values (0,1, . . . , k−1). In the case of k=3, the solution is a path that goes in the sequence of “0” to “1”, “1” to “2”, and then reverts back to “0” to repeat the sequence.

It will be readily understood that visually distinguishable indicators depicted on the tiles can be of substantially any visual form such as, but not limited to, color, letters, numerals, icons, graphic symbols and the like. Any adaptation for visually impaired users by the use of physical, such as but not limited to brail markings, and/or auditory sensory distinguishable indicators should also be considered within the spirit and score of the present invention.

The solution to the puzzle of the present invention follows a predetermined path along which there is a predetermined relationship between each of the tiles along the solution path. This predetermined relationship includes, but is not limited to, the allowable direction of movement from one tile to the next tile along the solution path, also referred to herein as “adjacency”, such as, by non-limiting example, one square vertically or one square horizontally (as in a Plus sign or a Castle in chess); one square vertically, horizontally or diagonally (as a King in chess); or three squares horizontally and one vertically or three vertically and one horizontally (as a Knight in chess). It should be noted that the terms “step”, “connection” and “move” may be used interchangeably herein and all three terms refer to movement according to the predetermined solution path of the puzzle.

It should be noted that the use of the term “grid”, which usually connotes substantially horizontal and vertical lines, and the term “tile(s)” are used herein as non-limiting examples only and that the relationship between associated positions on the field of play of the BitChain puzzle game of the present invention need not be limited to a grid per se. That is to say, the outer contour of the field of play need not be square or rectangular, but may take any shape such as, but not limited to, circles and other closed curves, and the outer contour of animate and inanimate objects such as, but not limited to, toys, vehicles, plants and animals. Further, the shape of the place on the field of play upon which numerals are placed is not to be limited by the term “square(s)” as used herein, the term “square(s)” is intended to include substantially all representations of a point or substantially any non-rectangular shape such as, but not limited to, triangles, pentagons, hexagons and circles and other closed curves, as well as squares and rectangles.

It is preferable that a puzzle should have a single solution and that the solution should not require trial-and-error or backtracking. Rather that the solution may be found by logic.

It will be appreciated that puzzles may be of various levels of difficulty from very easy to very hard. Further, the size of the field of play/board may be varied independent of, or in conjunction with, the difficulty level. That is, board sizes (the number of tiles on the grid) and shapes of both the board and the tiles may vary. For example 5 squares by 5 squares, 5 squares by 7 squares, 10 squares by 10 squares or any other sizes for a rectangular board. Variation of size and level may also be provided for puzzle having non-rectangular outer contours, as mentioned above.

It will be appreciated that the field of play, which generally configured as a pattern of associated cells, may be represented by a game play interface in a variety of ways such as, but not-limited to, printed material and electronic displays. When the game play interface is printed material, the puzzle may be solved using a writing utensil such as a pen or pencil for example. When the game play interface is electronic, the puzzle is depicted on the electronic display of such devices as, but not limited to, personal computers both desktop and laptop, game consoles, cellular phones, PDAs, TV set, and handheld electronic game platforms such as GameBoy™. When thusly displayed, the puzzle may be solved using standard input devices such as, but not limited to, keyboards, a mouse, game pads, joysticks and touch screens.

When the game is displayed electronically, a computer program controls the display, input and logic. The computer program can also store various pre-made puzzles and or create new ones. The computer program may also be configured to provide help to the player upon request by giving hints such as, but not limited to:

1. Showing all valid moves from a particular square.

2. The status of each tile.

3. A partial or full solution of the puzzle.

4. Warnings in case the player has made an error of some kind.

5. Hints such as, but not limited to, the next move.

Puzzles of the present invention can be created at random or systematically. Further, the puzzles and solutions may be transferred through compute networks such as, but not limited to, LANs, WANs, the Internet and e-mail. Alternatively, a server computer may be configured to provide client computers with puzzles and solutions upon request via LANs, WANs, and the Internet.

Creation of a puzzle according to the present invention includes the following procedure. It will be understood that the creation of a BitChain puzzle requires a device such as, but not limited to, a printer or a computer to interact with, and transform, a blank display element such as, but not limited to a sheet of paper or an electronic display, into a game play interface. As the player solves the puzzle, the game play interface may be visually changed by the player's interaction with the game play interface.

Set the Puzzle Parameters which Include, but are not Limited to:
Tile type (hexagonal, square, triangular, etc.)
Adjacency (Hex, Plus, King, Knight, etc.)
Board size and shape MinWalkLen=Minimum length of the solution.
Level=difficulty level of the puzzle. K=number of markings in the puzzle.

Create a Game Play Interface:
1. Create an empty board B.
2. Perform a random walk on B. Sequentially number the tiles in the solution (0,1,2, . . . , n)
3. Repeat step 2 until the walk length n is at least MinWalkLen.
4. Mark all empty squares as blocked.
5. Let S be the result of step 4. S is the solution of the puzzle we build.
6. P=S
7. Add to P walls between all adjacent tiles that are not connected by S
8. Assign each tile its value modulo K.
9. Remove some of the restrictions from P (e.g. wall(s), line(s) connecting two tiles, value assign to a tile, etc.)
10. Solve P applying only rules of level<=Level.
11. If P is solved go to 9.
12. Undo last action from step 9.
13. Check that P confirms to additional criteria, if not go to 6.
14.P is the puzzle, S is it's solution

Additional Criteria:
a. P has only one solution (optional).
b. Etc.

Create a solution using the following Solution Algorithms/Rules

Definitions:
Tile: any position (square) on the board.
Blocked Tile: a Tile that does not participate (colored black).
Empty Tile: a Tile with unknown value (white).
Active 1 Tile: An tile marked as end or start that is not connected to other tiles or a non-end tile that is connected to only one other tile.
Active2: A non-end tile that is not connected to any other tiles.
Active=Active2 or Active 1 Inactive: A non-Active tile.
Passive=Inactive or Blocked.
Neighbor: Tile P is neighbor of Q if it is adjacent to P and no other constraints prevent the solution to connect them.

Rules:

Rule 1: If an Active 1 has one Active neighbor→connect them.
Rule2: If an Active2 has two Active neighbors→connect it to both.
Rule3: If an Active 1 has no Active neighbors>Fail and backtrack.

Finite Constraint Solving Algorithms:

By tracking all valid paths between two given values we can set up constraint sets for every empty Tile. Similarly for the lowest and highest known values, these constraint sets can be solved by known algorithms.

Referring now to the drawings, it will be appreciated the elements that are common to multiple figures are referenced throughout the drawings with similar reference numerals.

FIG. 1 illustrates a BitChain puzzle game field of play 10 according to the teaching of the present invention, in which the tiles are hexagonal in shape, therefore, the “adjacency”, or the allowable direction of movement from one tile to the next tile, is to any adjoining tile. The start/end tiles 14 are marked by a circle pattern within the two tiles.

In this illustration k=2, therefore, there are two visually distinguishable indicators that are indicated here by “0” and “1”.

The solution of the puzzle is a path that begins at either one of the start/end tiles and passes through all of the tiles in the field of play alternating between tiles marked with “0” and “1”.

The difficulty of this puzzle is also determined by the number of tiles in the field of play.

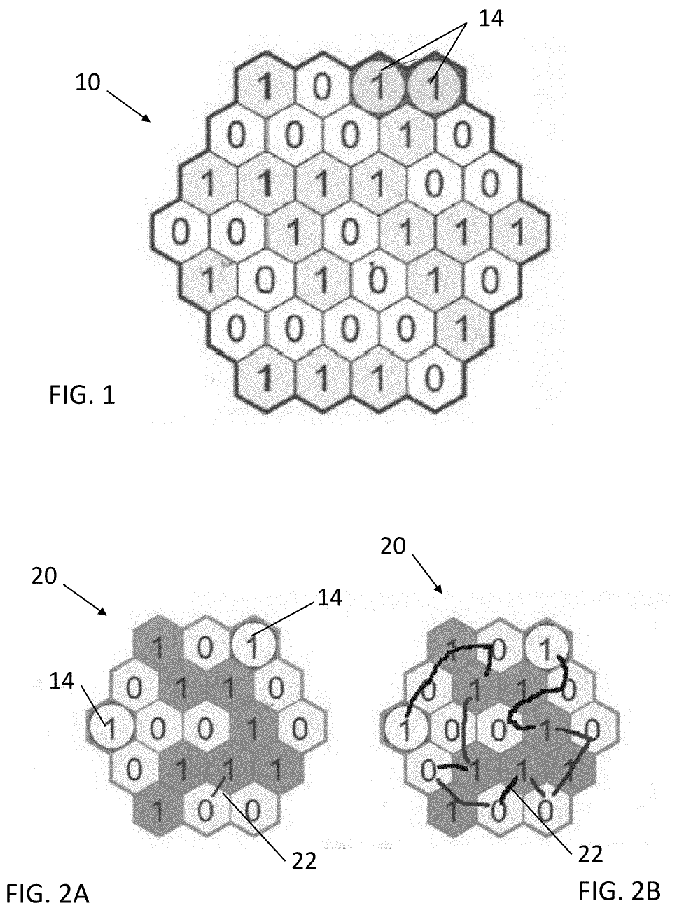

FIG. 2A illustrates a BitChain puzzle similar to the puzzle of Figure albeit with a smaller field of play 20. The tiles are hexagonal, k=2, and the start/end tiles 14 are marked. Also illustrated here in FIG. 2A is line 22 connecting two adjacent tiles as a “given” in the solution path of this puzzle. Therefore, the solution path must include line 22, as is seen in FIG. 2B.

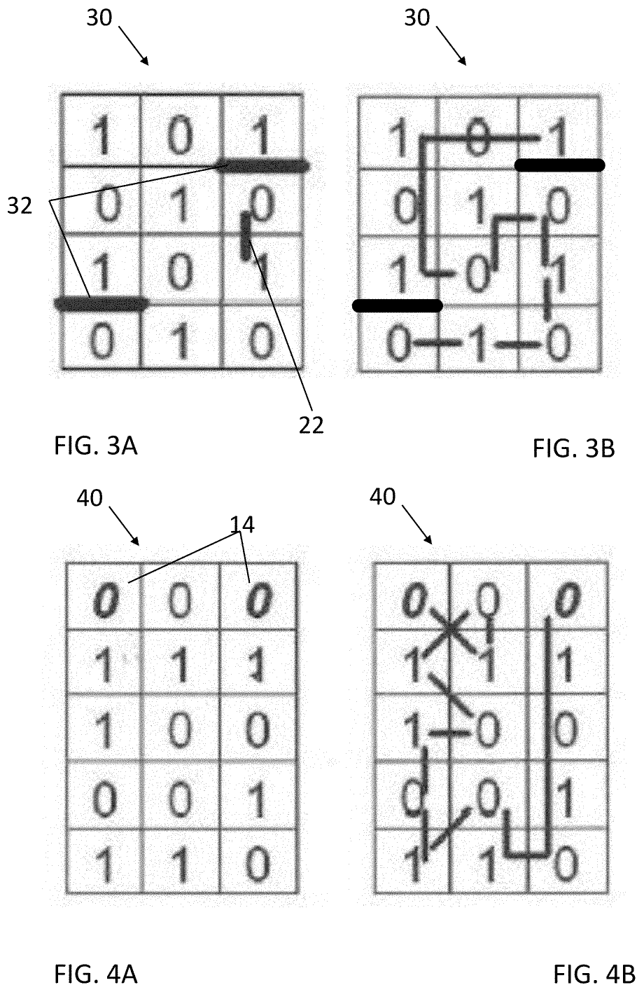

FIG. 3A illustrates a BitChain puzzle game field of play 30 according to the teaching of the present invention, in which the tiles are square in shape and the field of play is set as a 3 tile by 4 tile grid. For this puzzle the “adjacency” has been set as a Plus or a Castle, that is, one tile vertically or one tile horizontally. The start/end tiles are not marked.

In this illustration k=2 and the visually distinguishable indicators are also “0” and “1” and the solution path must pass through alternating tiles.

There is a single “given”, line 22, connecting two adjacent tiles. Also illustrated here are two “walls” 32 through which the solution path must not pass, as seen in the solution illustrated in FIG. 3B.

FIG. 4A illustrates a BitChain puzzle game field of play 40 according to the teaching of the present invention, in which the tiles are square in shape and the field of play is set as a 3 tile by 5 tile grid. For this puzzle the “adjacency” has been set as a King in chess, one square vertically, horizontally or diagonally. The start/end tiles 14 are marked.

In this illustration k=2 and the visually distinguishable indicators are also “0” and “1” and the solution path must pass through alternating tiles.

The solution of the puzzle of FIG. 4A is a path that begins at either one of the start/end tiles 14 and passes through all of the tiles in the field of play alternating between tiles marked with “0” and “1”, as seen in the solution illustrated in FIG. 4B.

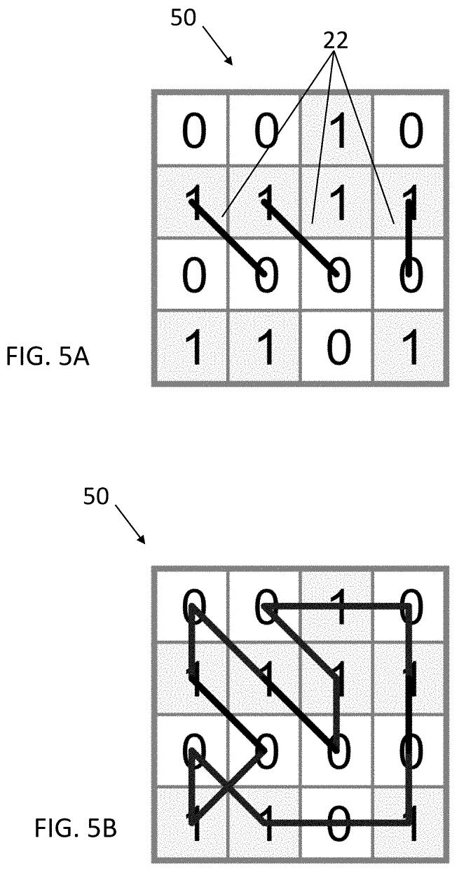

FIG. 5A illustrates a BitChain puzzle game field of play 50 according to the teaching of the present invention, in which the tiles are square in shape and the field of play is set as a 4 tile by 4 tile grid. For this puzzle the “adjacency” has been set as a King in chess, one square vertically, horizontally or diagonally.

In this illustration k=2 and the visually distinguishable indicators are also “0” and “1” and the solution path must pass through alternating tiles.

There are three “given” lines 22, each connecting two adjacent tiles.

Also illustrated here is the feature of a closed loop cyclic solution path, such that the solution of the puzzle is a path that begins at any one of the tiles in the field of play, passes through all of the tiles in the field of play in the alternating pattern set of the puzzle and returns to the first tile.

Therefore, the solution of the puzzle of FIG. 5A is a path that begins at any tile in the field of play, passes through all of the tiles in the field of play alternating between tiles marked with “0” and “1”, while including all three of the “given” lines 22 and returns to the at which the path was begun, as seen in the solution illustrated in FIG. 5B.

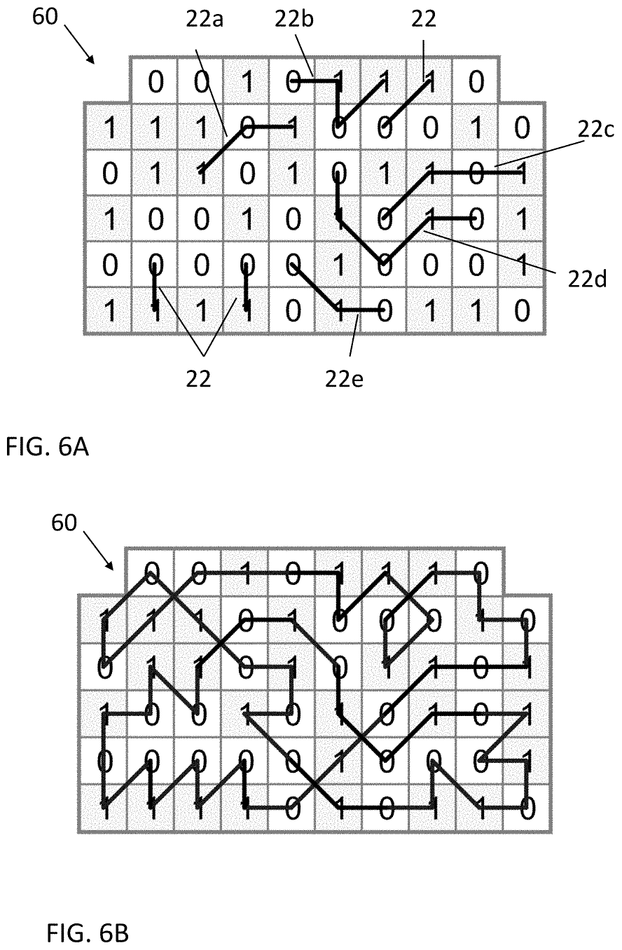

FIG. 6A illustrates a BitChain puzzle game field of play 60 according to the teaching of the present invention that is similar to the puzzle of FIG. 5A. For this puzzle the “adjacency” has been set as a King in chess, one square vertically, horizontally or diagonally.

In this illustration k=2 and the visually distinguishable indicators are also “0” and “1” and the solution path must pass through alternating tiles.

Illustrated here is the feature of multiple “given” lines 22, some of which pass through multiple tiles, as illustrated by given lines 22a, 22b, 22c, 22d and 22e.

The solution path has also been set as a cyclic solution path. Therefore, the solution of the puzzle of FIG. 6A is a path that begins at any tile in the field of play, passes through all of the tiles in the field of play alternating between tiles marked with “0” and “1” while including all of the “given” lines 22 and returns to the tile at which the path was begun, as seen in the solution illustrated in FIG. 6B.

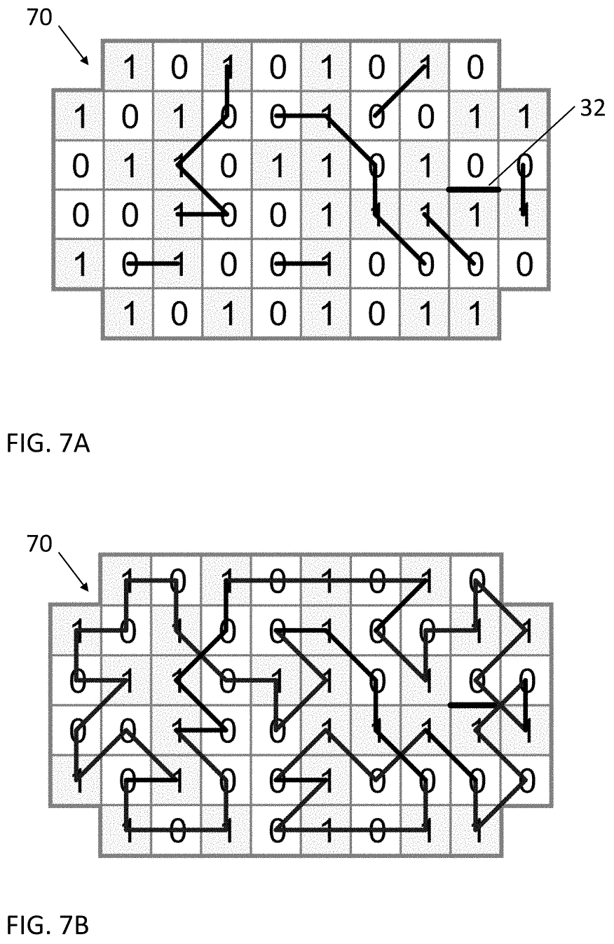

FIG. 7A illustrates a BitChain puzzle game field of play 70 that is similar to the puzzle of FIG. 6A. For this puzzle the “adjacency” has been set as a King in chess, one square vertically, horizontally or diagonally. The solution path has also been set as a cyclic solution path.

In this illustration k=2 and the visually distinguishable indicators are also “0” and “1” and the solution path must pass through alternating tiles.

There are multiple “given” lines 22, some of which pass through multiple tiles. There is also one “wall” 32.

The solution of the puzzle of FIG. 7A is a path that begins at any tile in the field of play, passes through all of the tiles in the field of play alternating between tiles marked with “0” and “1” while including all of the “given” lines 22 and returns to the tile at which the path was begun without passing through the “wall” 32, as seen in the solution illustrated in FIG. 7B.

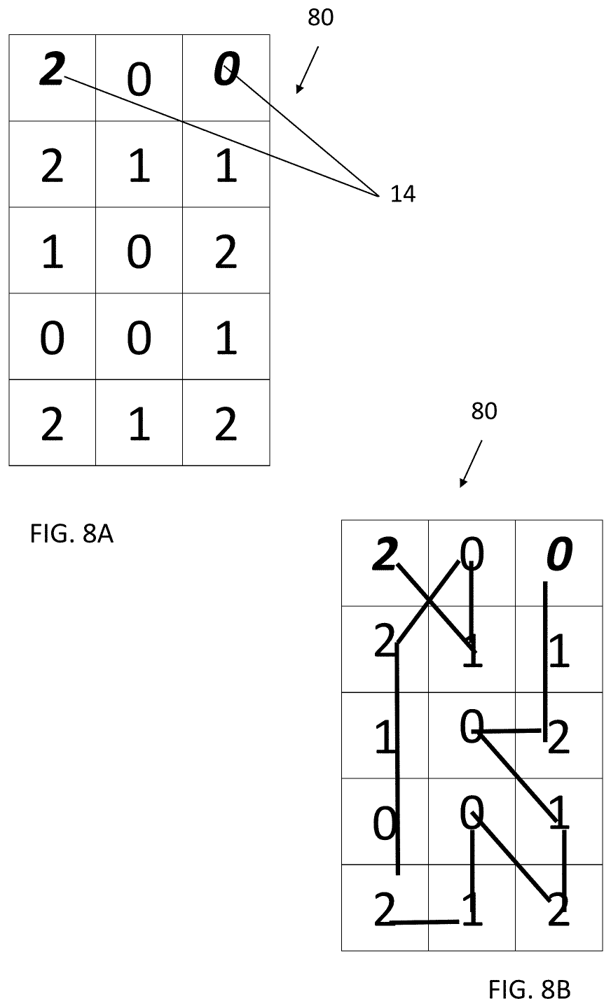

FIG. 8A illustrates a BitChain puzzle game field of play 80 in which the tiles are square in shape and the field of play is set as a 3 tile by 5 tile grid. For this puzzle the “adjacency” has been set as a King in chess, one square vertically, horizontally or diagonally. The start/end tiles 14 are marked.

In this illustration k=3 and the visually distinguishable indicators are “0”, “1” and “2”. Therefore, the solution path must pass through an alternating sequence of tiles marked “0”, “1”, “2” and then repeat the sequence. Alternately, the player may choose to do the sequence in the opposite order, “2”, “1”, “0”.

Therefore, the solution of the puzzle of FIG. 8A is a path that begins at either one of the start/end tiles 14 and passes through all of the tiles in the field of play alternating between tiles marked with “0”, “1” and “2” in either ascending or descending order, as seen in the solution illustrated in FIG. 8B.

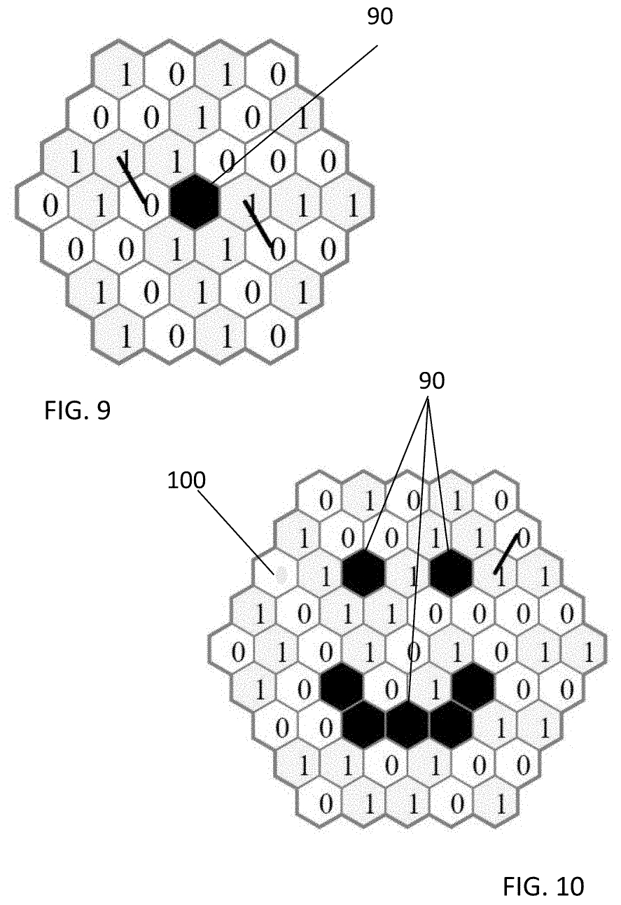

FIGS. 9 and 10 are brought in order to illustrate the feature of tiles 90 that are excluded from the field of play. These tiles 90 are black in color so as to noticeably indicate as blocked from play,

FIG. 10 also illustrates the feature of an empty tile 100 that is included in the field of play to be filled by the player while solving the puzzle.

It will be appreciated that the above descriptions are intended only to serve as examples and that many other embodiments are possible within the spirit and the scope of the present invention.

What is claimed is:

1. A puzzle game comprising: a game play interface configured to display a pattern of associated cells with at least some of said associated cells containing a visually distinguishable indicator, said visually distinguishable indictor being one of two or more types, such that said visually distinguishable indicator indicates an individual associated cell's order in a repeating sequence along a predetermined solution path in said pattern of associated cells and said pattern of associated cells is configured such said solution path is traced by passing through all said associated cells in said pattern while maintaining said repeating sequence of said visually distinguishable indicators and without traversing any cell twice.

2. The puzzle game of claim 1, wherein said game play interface is represented on an electronic display.

3. The puzzle game of claim 1, wherein all of said associated cells in said pattern contain a visually distinguishable indicator.

4. The puzzle game of claim 1, wherein said visually distinguishable indicators are at least one chosen from a group including visual forms such as, but not limited to, colors, letters, numerals, icons and graphic symbols.

5. The puzzle game of claim 1, wherein a predetermined relationship between each one of said associated cells includes, but is not limited to, an allowable direction of movement from one said associate cell to a next associated cell on said solution path.

6. The puzzle game of claim 5, wherein said allowable direction of movement is similar to a move that can be made by a chess piece on a chessboard during a game of chess.

7. The puzzle game of claim 5, wherein said associated cells are hexagonal in shape and said allowable direction of movement is to any adjoining associated cell.

8. The puzzle game of claim 1, wherein a portion of said solution path is pre-placed in its predetermined position along said solution path by a game setter prior to a beginning of play.

9. The puzzle game of claim 1, wherein said solution path is configured such that there is a single solution path between a starting point and an end point.

10. The puzzle game of claim 1, wherein said solution path is configured such that said solution path is cyclic without a starting point and an end point.

11. The puzzle game of claim 1, further including a computer program programmed to at least:
(a) determine a type of said associated cells;
(b) determine adjacency of said associated cells;
(c) determine a size and shape of said pattern of associated cells; and
(d) determine a difficulty level of the puzzle.

12. The puzzle game of claim 11, wherein said computer program generates a game play interface displayed on said display element.

13. A method of forming a puzzle game, the method comprising:
(a) providing a computer program configured to determine at least one parameter of game play;
(b) generating a game play interface configured to display a pattern of associated cells with at least some of said associated cells containing a visually distinguishable indicator, said visually distinguishable indictor being one of two or more types, such that said visually distinguishable indicator indicates an individual associated cell's order in a repeating sequence along a predetermined solution path in said pattern of associated cells and said pattern of associated cells is configured such said solution path is traced by passing through all said associated cells in said pattern while maintaining said repeating sequence of said visually distinguishable indicators and without traversing any cell twice; and
(c) providing said game play interface to a device for presenting said game play interface to a user.

14. The method of claim 13, further including at least one algorithm for determining said at least one parameter of game play.

15. The method of claim 14, wherein said at least one parameter of game play includes at least one of:
(a) determine a type of said associated cells;
(b) determine adjacency of said associated cells;
(c) determine a size and shape of said pattern of associated cells; and
(d) determine a difficulty level of the puzzle.

16. The method of claim 15, wherein said adjacency is implemented as a move that can be made by a chess piece on a chessboard during a game of chess.

17. The method of claim 15, wherein said adjacency is implemented as a move to any adjoining associated cell.

18. The method of claim 13, wherein said game play interface is printed material.

19. The method of claim 13, wherein said game play interface is represented on an electronic display.

20. The puzzle game of claim 13, wherein said computer program is deployed on a server so as to provide game play to client devices.
